(19) United States
(12) Patent Application Publication
(10) Pub. No.: US 2025/0334855 A1
(43) Pub. Date: Oct. 30, 2025

(54) OPTICAL ELEMENT DRIVING MECHANISM

(71) Applicant: TDK Corporation, Tokyo (JP)

(72) Inventors: Pai-Jui CHENG, Taoyuan City (TW); Chao-Chang HU, Taoyuan City (TW); Shu-Shan CHEN, Taoyuan City (TW); Chuan-Min LEE, Taoyuan City (TW)

(73) Assignee: TDK Corporation, Tokyo (JP)

(21) Appl. No.: 19/188,349

(22) Filed: Apr. 24, 2025

Related U.S. Application Data
(60) Provisional application No. 63/639,384, filed on Apr. 26, 2024.

(51) Int. Cl. G03B 9/06

(52) U.S. Cl. CPC G03B 9/06

(57) ABSTRACT

An optical element driving mechanism includes a fixed assembly, a movable assembly, and a driving assembly. The movable assembly is configured to be connected to an optical assembly and is movable relative to the fixed assembly. The driving assembly is configured to drive the movable assembly to move relative to the fixed assembly. When at least a portion of the movable assembly moves relative to the fixed assembly, the optical assembly moves relative to the movable assembly.

### CROSS REFERENCE TO RELATED APPLICATIONS

This application claims the benefit of U.S. Provisional Application No. 63/639,384, filed on Apr. 26, 2024, the entirety of which is incorporated by reference herein.

### BACKGROUND OF THE INVENTION

### Field of the Disclosure

The present disclosure relates to an optical element driving mechanism, and in particular it relates to an optical element driving mechanism having with a piezoelectric element.

### Description of the Related Art

As technology has developed, many of today's electronic devices (such as smartphones) have a camera or video functionality. Using the camera modules disposed on electronic devices, users can operate their electronic devices to capture photographs and record videos.

Today's design of electronic devices continues to follow the trend of miniaturization, meaning that the various components of the camera module or its structure must also be continuously reduced, so as to achieve miniaturization. In general, a driving mechanism in the camera module has a camera lens holder configured to hold a camera lens, and the driving mechanism can have the functions of auto focusing or optical image stabilization. Although existing driving mechanisms can achieve the aforementioned functions of photographing and video recording, however, they still cannot meet all users' needs.

Therefore, how to design a camera module that can be rapidly positioned and perform multiple functions are topics nowadays that need to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism is provided and includes a fixed assembly, a movable assembly, and a driving assembly. The movable assembly is configured to be connected to an optical assembly and is movable relative to the fixed assembly. The driving assembly is configured to drive the movable assembly to move relative to the fixed assembly. When at least a portion of the movable assembly moves relative to the fixed assembly, the optical assembly moves relative to the movable assembly.

According to some embodiments, the fixed assembly includes a casing and a base. The casing and the base are arranged along a main axis. The movable assembly includes a first stator which is fixedly connected to the base. The movable assembly further includes a first rotor which is movably connected to the first stator. The movable assembly further includes a first rolling ball which is disposed between the first stator and the first rotor. The first rotor rotates around a first rotating axis relative to the first stator by the first rolling ball. The first rotating axis is parallel to the main axis. The first rotating axis overlaps the main axis.

According to some embodiments, the optical element driving mechanism further includes a first positioning base which is connected to the base. The optical element driving mechanism further includes a first connecting element which extends along a first axis. The first axis is perpendicular to the main axis. The first connecting element is configured to connect the driving assembly to the first positioning base.

According to some embodiments, the base has an installation part. The first positioning base is configured to be inserted into the installation part along the first axis. The base has a first accommodation space which is configured to accommodate at least a portion of the driving assembly and the first positioning base.

According to some embodiments, the driving assembly has a first transfer assembly, a first contact member and a first power source. The first power source is configured to generate a first driving force configured to push the first transfer assembly. The first transfer assembly is configured to transmit the first driving force. The first contact member is disposed on the first transfer assembly and configured to transmit the first driving force.

According to some embodiments, the first accommodation space has a first avoiding space which corresponds to the first transfer assembly. The first contact member is configured to drive the first rotor to rotate relative to the first stator around the first rotating axis according to the first driving force.

According to some embodiments, when viewed along the main axis, the first positioning base has a plate-shaped structure. The first positioning base has a main body, a first side protruding portion and a second side protruding portion. The first side protruding portion and the second side protruding portion protrude from the main body along a second axis. The installation part has a first guiding groove and a second guiding groove which are configured to accommodate the first side protruding portion and the second side protruding portion respectively. When viewed along the first axis, the first side protruding portion and the second side protruding portion each have a trapezoidal structure.

According to some embodiments, the main body has a first surface which is perpendicular to the second axis. The second axis is perpendicular to the first axis and the main axis. The first side protruding portion and the second side protruding portion respectively have a second surface and a third surface. The second surface is not parallel to the third surface. The second surface is neither parallel nor perpendicular to the first surface.

According to some embodiments, the optical element driving mechanism further includes a first positioning element and a second positioning element which are configured to position the first positioning base at the installation part. The first positioning base has a first positioning groove and a second positioning groove. The installation part further has a third positioning groove and a fourth positioning groove which respectively correspond to the first positioning groove and the second positioning groove.

According to some embodiments, the first positioning element is configured to be disposed in the first positioning groove and the third positioning groove. The second positioning element is configured to be disposed in the second positioning groove and the fourth positioning groove. The first positioning element and the second positioning element are configured to push the first positioning base so that the first positioning base provides a pre-pressure to the first contact member.

According to some embodiments, when viewed along the main axis, the first positioning groove and the second positioning groove each have a polygonal structure. When viewed along the main axis, the third positioning groove and the fourth positioning groove each have a polygonal structure. The first positioning element and the second positioning element each have a spherical structure or a columnar structure. The first positioning element and the second positioning element are made of non-metallic material.

According to some embodiments, when viewed along the main axis, the first stator has a ring-shaped structure and forms a light-entering opening. The optical assembly includes an optical element which is configured to selectively shield a portion of the light-entering opening. The optical element driving mechanism further includes a fixed protruding portion and a movable protruding portion which extend along the main axis.

According to some embodiments, the optical element has a movable trench which corresponds to the fixed protruding portion. The fixed protruding portion is disposed on the first stator and passes through the movable trench. The movable protruding portion is disposed on the first rotor and passes through the optical element. When the first rotor rotates relative to the first stator, the first rotor drives the optical element to rotate around the movable protruding portion as an axis, so that the fixed protruding portion and the movable trench move relative to each other.

According to some embodiments, the first stator and the first rotor are made of a metal material. The first stator and the first rotor have a first accommodation groove and a second accommodation groove respectively. The first rolling ball is disposed in the first accommodation groove and the second accommodation groove. The first rolling ball has a spherical structure.

According to some embodiments, when viewed along the main axis, the first stator and the first rotor each have a ring-shaped structure. The first accommodation groove is circumferentially formed on the first stator. The second accommodation groove is circumferentially formed on the first rotor. The first accommodation groove has a first contact surface which is configured to contact the first rolling ball. The second accommodation groove has a second contact surface which is configured to contact the first rolling ball. The first accommodation groove or the second accommodation groove further has a third contact surface which is configured to contact the first rolling ball. The first contact surface, the second contact surface and the third contact surface are neither parallel to nor perpendicular to each other.

According to some embodiments, the base further has a positioning protruding portion, and the first stator is configured to be affixed to the positioning protruding portion. The optical element driving mechanism further includes a first sensing element which is disposed at the positioning protruding portion. The first sensing element is located between the positioning protruding portion and the first stator. The optical element driving mechanism further includes a first magnetic element which is disposed on the first rotor. The first sensing element is configured to sense magnetic field changes of the first magnetic element. The first rotor is located between the first magnetic element and the first stator.

According to some embodiments, the optical element driving mechanism further includes a covering body and a connecting member. The covering body is fixedly connected to the first rotor. The connecting member is fixedly connected to the first stator. The base further has a positioning protruding portion, and the connecting member is configured to be affixed to the positioning protruding portion. When viewed along the main axis, the connecting member has a ring-shaped structure and forms a light-entering opening. The optical assembly includes an optical element which is configured to selectively shield a portion of the light-entering opening.

According to some embodiments, the optical element driving mechanism further includes a fixed protruding portion and a movable protruding portion which extends along the main axis. The optical element has a movable trench which corresponds to the fixed protruding portion. The fixed protruding portion is disposed on the connecting member and passes through the movable trench. The movable protruding portion is disposed on the covering body and passes through the optical element. When the first contact member drives the first rotor and the covering body to rotate relative to the first stator, the covering body drives the optical element to rotate around the movable protruding portion as an axis, so that the fixed protruding portion and the movable trench move relative to each other.

According to some embodiments, the base, the connecting member and the covering body are made of plastic material. The first stator and the first rotor are made of metal material. The covering body has a ring-shaped structure, and the covering body has an opening slot which extends circumferentially. The angular span of the opening slot is less than 180 degrees. The first contact member is configured to pass through the opening slot to contact the first rotor.

According to some embodiments, the optical element driving mechanism further includes a first sensing element which is disposed at the base. The first sensing element is located between the base and the covering body. The optical element driving mechanism further includes a first magnetic element which is disposed on the covering body. The first sensing element is configured to sense magnetic field changes of the first magnetic element.

The present disclosure provides an optical element driving mechanism, including a fixed assembly, a movable assembly, and a driving assembly. The movable assembly includes a first stator and a first rotor. The first stator is affixed to the base of the fixed assembly, and the first rotor is movably connected to the first stator. The driving assembly is configured to drive the first rotor to move relative to the first stator to drive the plurality of optical elements to move, so as to adjust the amount of light entering the optical element driving mechanism. The optical elements may be, for example, shielding blades forming an aperture structure, but they are not limited thereto.

In some embodiments, a plurality of fixed protruding portions are disposed on the first stator and pass through the movable trenches of the corresponding optical elements, and a plurality of movable protruding portions are disposed on the first rotor and pass through the corresponding optical elements. When the first rotor rotates relative to the first stator, the first rotor drives each optical element to rotate about the corresponding movable protruding portion, so that the fixed protruding portion and the corresponding movable trench move relative to each other. The fixed protruding portions may be integrally formed with the first stator, the movable protruding portions may be integrally formed with the first rotor, and the fixed protruding portions and the movable protruding portions may be made of a metal material. Based on this configuration, the manufacturing steps can be simplified and the goal of miniaturization can be achieved.

In addition, the optical element driving mechanism may further include a first positioning base which is configured to position the driving assembly onto the installation part of the base. The first positioning base may have a first side protruding portion and a second side protruding portion, and the installation part may have a first guiding groove and a second guiding groove to guide the first side protruding portion and the second side protruding portion, respectively. Based on this configuration, the convenience of assembly can be increased, and the problem that the first positioning base rotates relative to the base around the first central axis when the driving assembly drives the first rotor can be avoided.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an optical element driving mechanism 100 according to an embodiment of the present disclosure.

FIG. 2 is an exploded diagram of the optical element driving mechanism 100 according to an embodiment of the present disclosure.

FIG. 3 is a cross-sectional view of the optical element driving mechanism 100 along line A-A in FIG. 1 according to an embodiment of the present disclosure.

FIG. 4 is a perspective view of a partial structure of the optical element driving mechanism 100 in another view according to an embodiment of the present disclosure.

FIG. 5 is a top view showing that the driving assembly DA drives the first rotor 122 to rotate in a first rotation direction RD1 relative to the first stator 121 according to an embodiment of the present disclosure.

FIG. 6 is a top view showing that the driving assembly DA drives the first rotor 122 to rotate in a second rotation direction RD2 relative to the first stator 121 according to an embodiment of the present disclosure.

FIG. 7 is an exploded diagram of an optical element driving mechanism 100A according to another embodiment of the present disclosure.

FIG. 8 is a cross-sectional view of the optical element driving mechanism 100A according to another embodiment of the present disclosure.

FIG. 9 is a cross-sectional view of an optical element driving mechanism 100B according to another embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

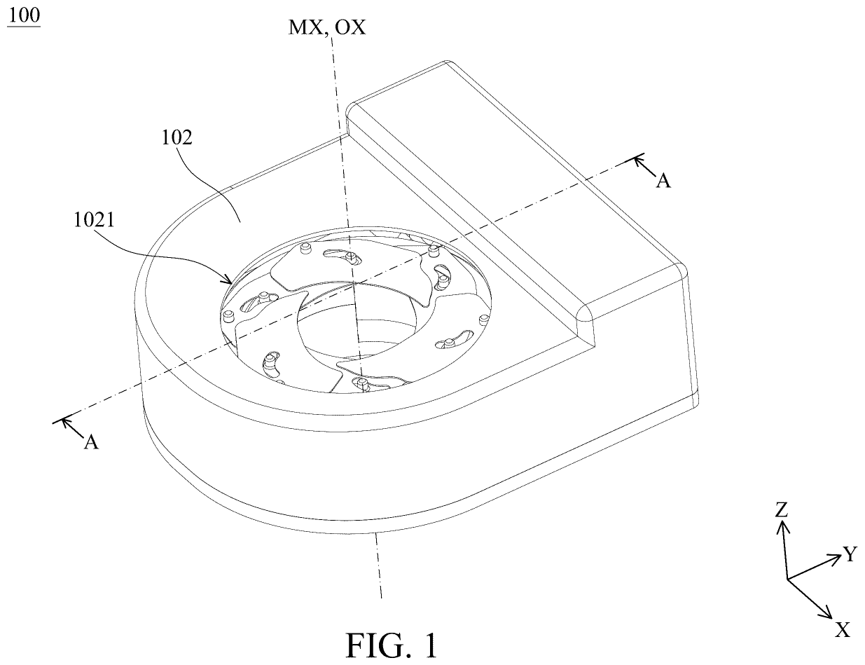

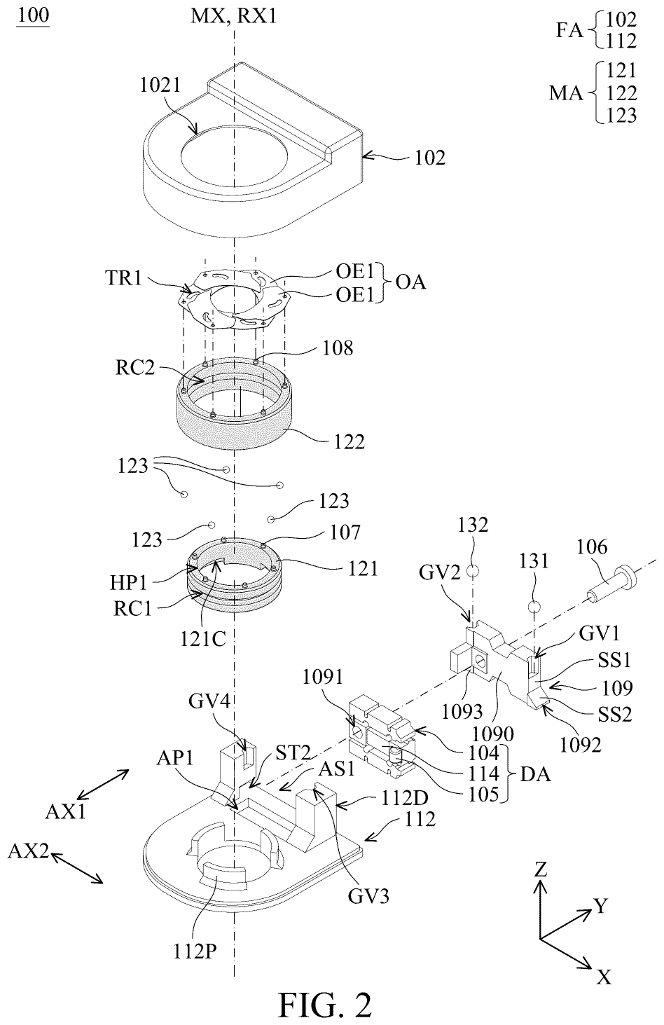

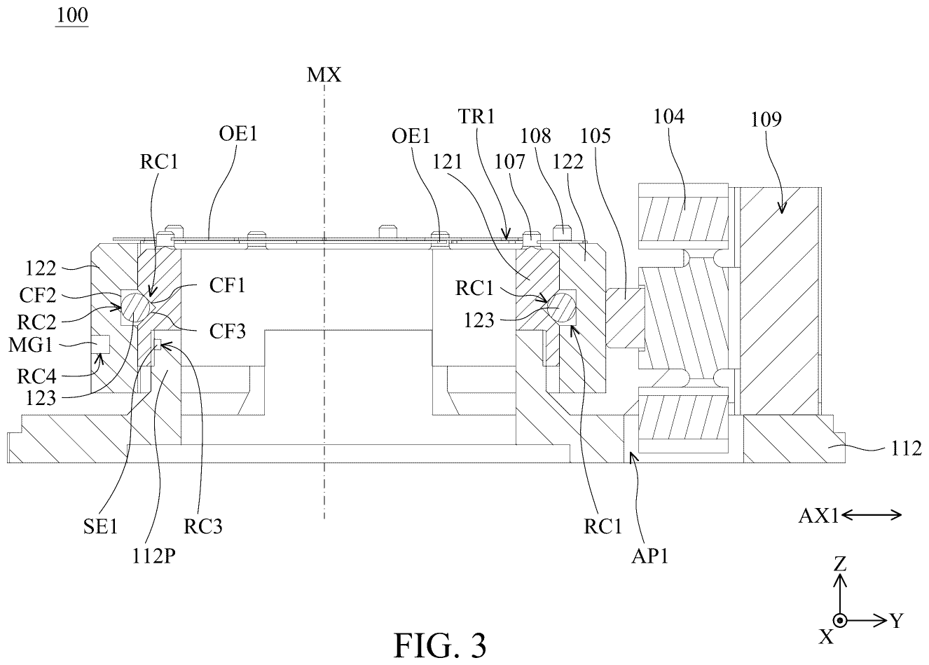

Please refer to FIG. 1 to FIG. 3. FIG. 1 is a schematic diagram of an optical element driving mechanism 100 according to an embodiment of the present disclosure, FIG. 2 is an exploded diagram of the optical element driving mechanism 100 according to an embodiment of the present disclosure, and FIG. 3 is a cross-sectional view of the optical element driving mechanism 100 along line A-A in FIG. 1 according to an embodiment of the present disclosure. The optical element driving mechanism 100 can be an optical camera system and can be configured to hold and drive an optical element (such as a camera lens, not shown in figures). The optical element driving mechanism 100 can be installed in various electronic devices or portable electronic devices, such as a smart TV or a smartphone, for allowing a user to perform the image capturing function.

In this embodiment, the optical element driving mechanism 100 may include a fixed assembly FA, a movable assembly MA, an optical assembly OA, and a driving assembly DA. The movable assembly MA is configured to be connected to the optical assembly OA, and the movable assembly MA is movable relative to the fixed assembly FA. The driving assembly DA is configured to drive the movable assembly MA to move relative to the fixed assembly FA. When a portion of the movable assembly MA moves relative to the fixed assembly FA, the optical assembly OA is movable relative to the movable assembly M A.

As shown in FIG. 2, the fixed assembly FA may include a casing 102 and a base 112. The casing 102 and the base 112 are arranged along a main axis MX, and the casing 102 is fixedly connected to the base 112.

The casing 102 may have a casing opening 1021, and an external light may enter the casing opening 1021 along an optical axis OX of the optical element, and then pass through the optical element (the camera lens) and received by a photosensitive element (not shown) to generate a digital image. The optical axis OX may be parallel to or overlap the main axis M X, but it is not limited thereto.

The movable assembly MA may include a first stator 121 which is fixedly connected to the base 112, and the movable assembly MA may further include a first rotor 122 which is movably connected to the first stator 121. As shown in FIG. 3, the base 112 further includes a positioning protruding portion 112P, and a positioning slot 121C of the first stator 121 is configured to be engaged and fixed on the positioning protruding portion 112P.

Specifically, the movable assembly MA may further include a plurality of first rolling balls 123 which are disposed between the first stator 121 and the first rotor 122, and the first rotor 122 rotates around a first rotating axis RX 1 relative to the first stator 121 by the first rolling balls 123. The first rotating axis RX 1 overlaps the main axis MX, but it is not limited thereto. In other embodiments, the first rotating axis RX 1 may be only parallel to the main axis MX.

In this embodiment, the first stator 121, the first rotor 122 and the first rolling balls 123 can be made of metal material, and the first stator 121 and the first rotor 122 respectively have a first accommodation groove RC1 and a second accommodation groove RC2. The first rolling balls 123 are disposed in the first accommodation groove RC1 and the second accommodation groove RC2, and the first rolling balls 123 has a spherical structure.

As shown in FIG. 2, when viewed along the main axis MX, the first stator 121 and the first rotor 122 each have a ring-shaped structure, the first accommodation groove RC1 is circumferentially formed on the outer wall surface of the first stator 121, and the second accommodation groove RC2 is circumferentially formed on the inner wall surface of the first rotor 122.

Furthermore, as shown in FIG. 3, the first accommodation groove RC1 has a first contact surface CF1 which is configured to contact the first rolling balls 123, and the second accommodation groove RC2 has a second contact surface CF2 which is configured to contact the first rolling balls 123. In addition, the first accommodation groove RC1 or the second accommodation groove RC2 may further have a third contact surface CF3 which is configured to contact the first rolling balls 123.

In this embodiment, the third contact surface CF3 is included in the first accommodation groove RC1, but it is not limited thereto. It should be noted that the first contact surface CF1, the second contact surface CF2, and the third contact surface CF3 are neither parallel nor perpendicular to each other. In addition, the first rolling balls 123 may also contact other inner wall surfaces of the second accommodation groove RC2.

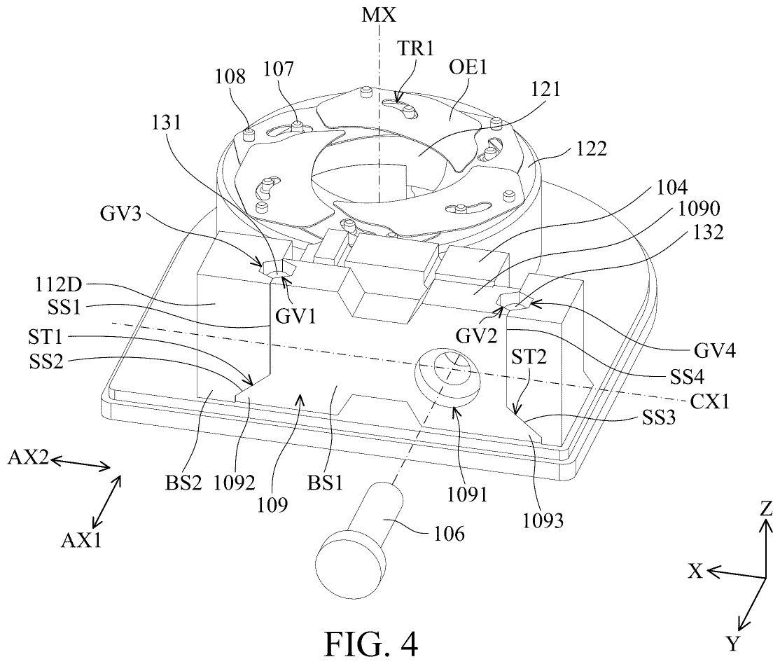

Please refer to FIG. 2 to FIG. 4. FIG. 4 is a perspective view of a partial structure of the optical element driving mechanism 100 in another view according to an embodiment of the present disclosure. As shown in FIG. 2 and FIG. 4, the optical element driving mechanism 100 further includes a first positioning base 109 which is connected to the base 112.

The optical element driving mechanism 100 further includes a first connecting element 106 which extends along a first axis AX1, and the first axis AX1 is perpendicular to the main axis MX. The first connecting element 106 is configured to connect the driving assembly DA to the first positioning base 109.

As shown in FIG. 4, the first connecting element 106 is configured to be inserted into a first positioning hole 1091 of the first positioning base 109 and then inserted into a first transfer assembly 104 of the driving assembly DA to affix the first transfer assembly 104 to the first positioning base 109. The first connecting element 106 is, for example, a screw, but it is not limited thereto.

Furthermore, the base 112 may have an installation part 112D, and the first positioning base 109 is configured to be inserted into the installation part 112D along the first axis AX1. The base 112 has a first accommodation space AS1 which is configured to accommodate at least a portion of the driving assembly DA and the first positioning base 109.

As shown in FIG. 4, when viewed along the main axis MX, the first positioning base 109 has a plate-shaped structure. The first positioning base 109 has a main body 1090, a first side protruding portion 1092 and a second side protruding portion 1093, and the first side protruding portion 1092 and the second side protruding portion 1093 protrude from the main body 1090 along a second axis AX2.

Correspondingly, the installation part 112D may have a first guiding groove ST1 and a second guiding groove ST2, configured to guide and accommodate the first side protruding portion 1092 and the second side protruding portion 1093 respectively. When the first positioning base 109 is inserted into the installation part 112D along the first axis AX1, the first side protruding portion 1092 and the second side protruding portion 1093 are respectively inserted into the first guiding groove ST1 and the second guiding groove ST2.

As shown in FIG. 4, when viewed along the first axis AX1, the main body 1090 has an H-shaped structure. When viewed along the first axis AX1, the first side protruding portion 1092 and the second side protruding portion 1093 each have a trapezoidal structure, and the first guiding groove ST1 and the second guiding groove ST2 each have a trapezoidal structure.

Specifically, as shown in FIG. 2 and FIG. 4, the main body 1090 may have a first surface SS1 and a fourth surface SS4 which are perpendicular to the second axis AX2, and the second axis AX2 is perpendicular to the first axis AX1 and the main axis MX.

The first side protruding portion 1092 and the second side protruding portion 1093 may respectively have a second surface SS2 and a third surface SS3, the second surface SS2 is not parallel to the third surface SS3, and the second surface SS2 is neither parallel to nor perpendicular to the first surface SS1 and the fourth surface SS4. In addition, the first surface SS1 is substantially parallel to the fourth surface SS4 (within a tolerance range), but they are not limited thereto.

Based on this configuration, it can prevent the first positioning base 109 from rotating around a first central axis CX 1 relative to the base 112 during the procedure of the driving assembly DA driving the first rotor 122. The first central axis CX 1 may, for example, pass through the center of gravity of the first positioning base 109, but it is not limited thereto.

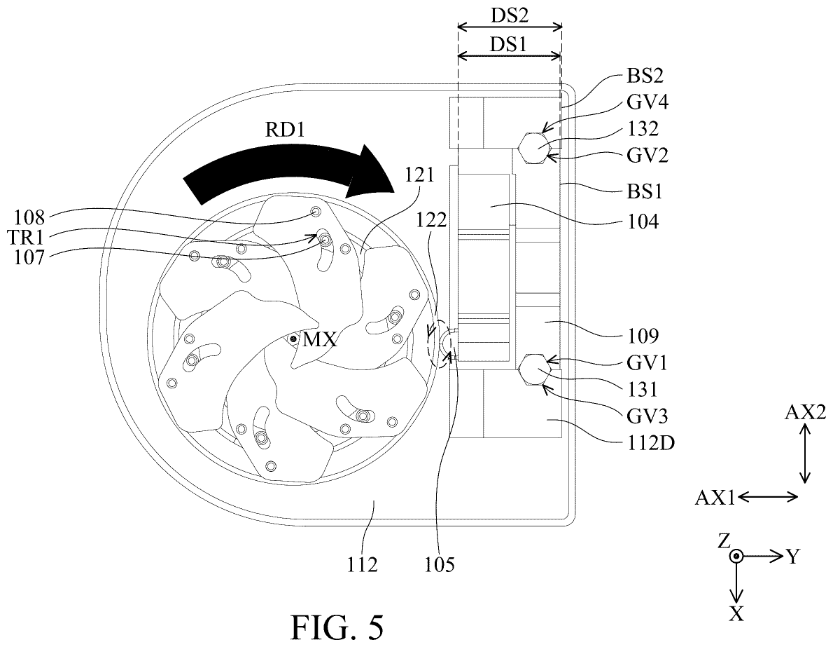

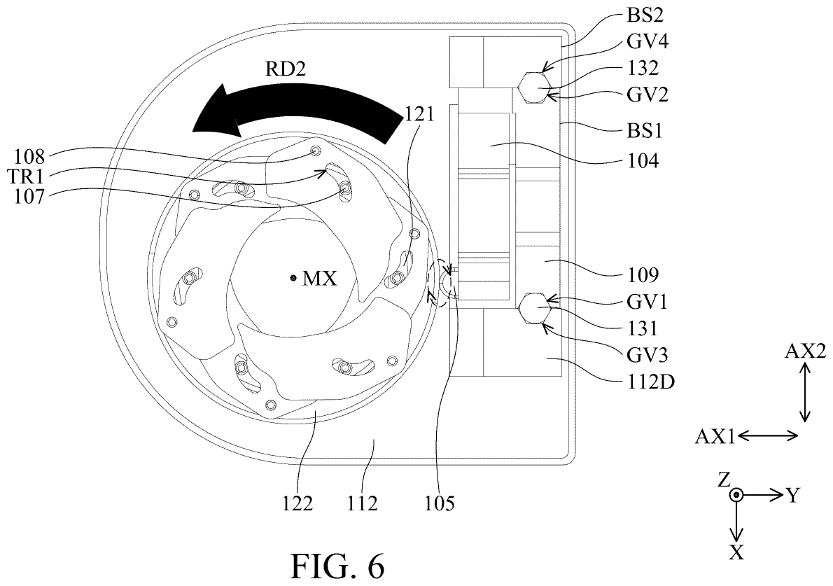

Next, please refer to FIG. 2, FIG. 3, and FIG. 5 to FIG. 6. FIG. 5 is a top view showing that the driving assembly DA drives the first rotor 122 to rotate in a first rotation direction RD1 relative to the first stator 121 according to an embodiment of the present disclosure, and FIG. 6 is a top view showing that the driving assembly DA drives the first rotor 122 to rotate in a second rotation direction RD2 relative to the first stator 121 according to an embodiment of the present disclosure.

As shown in FIG. 2 and FIG. 3, in this embodiment, the driving assembly DA may include the aforementioned first transfer assembly 104, a first contact member 105, and a first power source 114. The first power source 114 is configured to generate a first driving force, configured to push the first transfer assembly 104. The first transfer assembly 104 is configured to transmit the first driving force. The first contact member 105 is disposed on the first transfer assembly 104 and configured to transmit the first driving force.

In this embodiment, the first transfer assembly 104 has an elastic structure which can deform to output the first driving force. Specifically, the first power source 114 may be a piezoelectric element which is configured to deform to push the first transfer assembly 104, so that the first transfer assembly 104 is deformed to output the first driving force.

The first contact member 105 has a semi-cylindrical structure, which is fixedly disposed on the first transfer assembly 104 and is configured to transmit the first driving force. When the first transfer assembly 104 is deformed, the first contact member 105 is driven to move in an elliptical trajectory (when viewed along the main axis M X), thereby repeatedly contacting and driving the first rotor 122 to move. The operation manner of the first transfer assembly 104 and the first contact member 105 may be referred to China Patent Application No. 202420942976.X, and thus detailed description is omitted herein.

It should be notice that, as shown in FIG. 2 and FIG. 3, the first accommodation space AS1 may have a first avoiding space AP1 which corresponds to the first transfer assembly 104 so as to accommodate a portion of the first transfer assembly 104.

Based on this configuration, the problem that the first transfer assembly 104 collides with the base 112 when the driving assembly DA drives the first rotor 122 can be avoided. In addition, because a portion of the first transfer assembly 104 is accommodated in the first avoiding space AP1, the goal of miniaturization of the overall optical element driving mechanism 100 can be achieved.

Furthermore, as shown in FIG. 2, when viewed along the main axis MX, the first stator 121 forms a light-entering opening HP1, and the optical assembly OA includes a plurality of optical elements OE1 which are configured to selectively shield a portion of the light-entering opening HP1. The optical elements OE1 are, for example, shielding blades that forms an aperture structure.

Correspondingly, the optical element driving mechanism 100 may further include a plurality of fixed protruding portions 107 and a plurality of movable protruding portions 108 which extend along the main axis M X, and each optical element OE1 has a movable trench TR1 corresponding to the corresponding fixed protruding portion 107. Each of the fixed protruding portions 107 is disposed on the first stator 121 and passes through the corresponding movable trench TR1, and each of the movable protruding portions 108 is disposed on the first rotor 122 and passes through the corresponding optical element OE1.

As shown in FIG. 5, when the frequency of the driving signal received by the first power source 114 is 120 kHz, the first contact member 105 rotates counterclockwise to drive the first rotor 122 to rotate clockwise in the first rotation direction RD1 relative to the first stator 121. When the first rotor 122 rotates in the first rotation direction RD1 relative to the first stator 121, the first rotor 122 drives the plurality of optical elements OE1 to rotate around the corresponding movable protruding portion 108 as an axis, so that the fixed protruding portion 107 and the corresponding movable trench TR1 move relative to each other, thereby gradually shielding the light-entering opening HP1 so as to reduce the amount of incoming light.

On the contrary, as shown in FIG. 6, when the frequency of the driving signal received by the first power source 114 is 130 kHz, the first contact member 105 rotates clockwise to drive the first rotor 122 to rotate counterclockwise relative to the first stator 121 in the second rotation direction RD2.

When the first rotor 122 rotates relative to the first stator 121 in the second rotation direction RD2, the first rotor 122 drives the plurality of optical elements OE1 to rotate around the corresponding movable protruding portion 108 as an axis, so that the fixed protruding portion 107 and the corresponding movable trench TR1 move relative to each other, thereby gradually opening the light-entering opening HP1 to increase the amount of incoming light.

It is also worth noting that, in order that the driving assembly DA can accurately contact the first rotor 122 and thus correctly drive the first rotor 122, the first positioning base 109 needs to be correctly positioned to provide sufficient pre-pressure to the first contact member 105. Specifically, the optical element driving mechanism 100 may further include a first positioning element 131 and a second positioning element 132 which are configured to position the first positioning base 109 at the installation part 112D.

As shown in FIG. 4 and FIG. 5, the first positioning base 109 has a first positioning groove GV1 and a second positioning groove GV2, and the installation part 112D further has a third positioning groove GV3 and a fourth positioning groove GV4 respectively corresponding to the first positioning groove GV1 and the second positioning groove GV2.

The first positioning element 131 is configured to be disposed in the first positioning groove GV1 and the third positioning groove GV3, and the second positioning element 132 is configured to be disposed in the second positioning groove GV2 and the fourth positioning groove GV4.

When viewed along the main axis MX, the first positioning groove GV1 and the second positioning groove GV2 each have a polygonal structure, and when viewed along the main axis MX, the third positioning groove GV3 and the fourth positioning groove GV4 each have a polygonal structure. The first positioning groove GV1 is symmetrical to the third positioning groove GV3, and the second positioning groove GV2 is symmetrical to the fourth positioning groove GV4, but they are not limited thereto.

As shown in FIG. 5, the first positioning groove GV1 and the third positioning groove GV3 can form a hexagonal structure together, and the second positioning groove GV2 and the fourth positioning groove GV4 can form a hexagonal structure together, but they are not limited to this shape.

Since the positioning grooves have a symmetrical relationship, the inner wall surface of the first positioning groove GV1 can be parallel to the corresponding inner wall surface of the third positioning groove GV3. For example, the middle inner wall surface of the first positioning groove GV1 can be parallel to the middle inner wall surface of the third positioning groove GV3. Similarly, the inner wall surface of the second positioning groove GV2 can be parallel to the corresponding inner wall surface of the fourth positioning groove GV4. Furthermore, in some embodiments, the two hexagonal structures may be regular hexagons, but they are not limited thereto.

The first positioning element 131 and the second positioning element 132 may have a spherical structure or a columnar structure, and the first positioning element 131 and the second positioning element 132 are made of a non-metallic material, such as a ceramic material, but they are not limited thereto. Based on this configuration, the first positioning element 131 and the second positioning element 132 are configured to push the first positioning base 109 so that the first positioning base 109 provides the pre-pressure to the first contact member 105.

It should be noted that, as shown in FIG. 4 and FIG. 5, the first positioning base 109 further has a first back side surface BS1, and the installation part 112D further has a second back side surface BS2, and the first back side surface BS1 does not overlap the second back side surface BS2. That is, the first back side surface BS1 and the second back side surface BS2 are not on the same plane.

As shown in FIG. 5, on the first axis AX1, there is a first shortest distance DS1 between the first back side surface BS1 and the first contact member 105, there is a second shortest distance DS2 between the second back side surface BS2 and the first contact member 105, and the second shortest distance DS2 is greater than the first shortest distance DS1. Based on this configuration, the first positioning base 109 can provide sufficient pre-pressure to the first contact member 105.

Please go back to FIG. 3. As shown in FIG. 3, the optical element driving mechanism 100 may further include a first sensing element SE1 which is disposed on the positioning protruding portion 112P. For example, the first sensing element SE1 is disposed in a third accommodation groove RC3 of the positioning protruding portion 112P, and the first sensing element SE1 is located between the positioning protruding portion 112P and the first stator 121.

Correspondingly, the optical element driving mechanism 100 further includes a first magnetic element MG1 which is disposed on the first rotor 122. Specifically, the first magnetic element MG1 is disposed in a fourth accommodation groove RC4 of the first rotor 122, and the first rotor 122 is located between the first magnetic element MG1 and the first stator 121.

In this embodiment, the first sensing element SE1 is, for example, a Hall sensor or a tunneling magneto-resistance sensor (TMR sensor), and the first magnetic element MG1 is, for example, a Hall magnet, but they are not limited thereto.

The first sensing element SE1 is configured to sense the magnetic field changes of the first magnetic element MG1 to obtain the position of the first rotor 122 relative to the first stator 121. When viewed along the first axis AX1, the first sensing element SE1 partially or completely overlaps the first magnetic element MG1.

Based on this configuration, the first sensing element SE1 can accurately sense the magnetic field changes of the first magnetic element MG1, and the optical element driving mechanism 100 can also achieve the purpose of miniaturization.

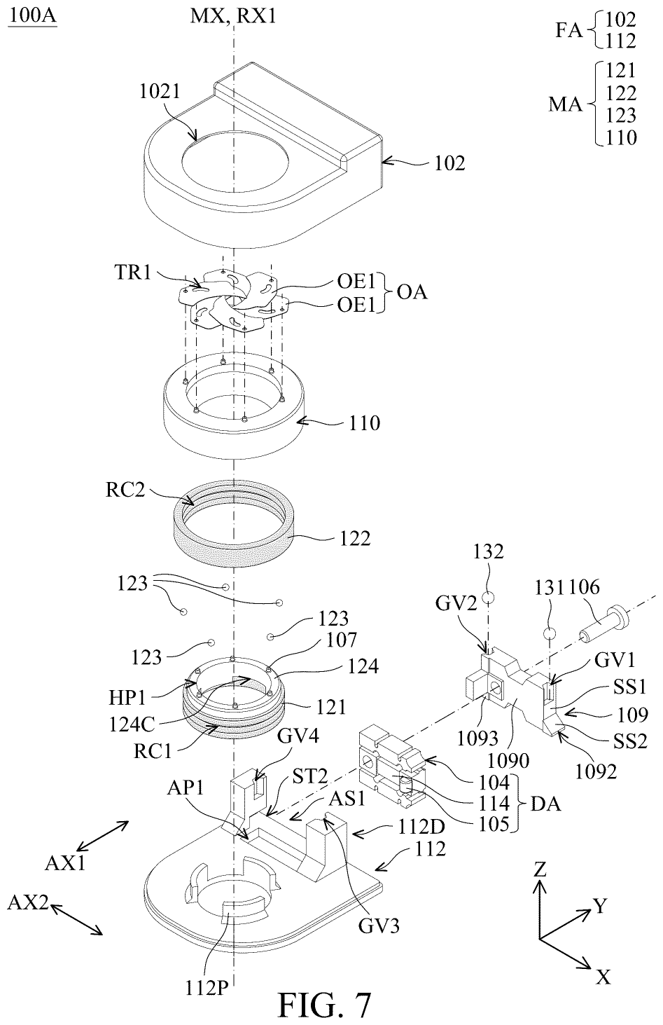

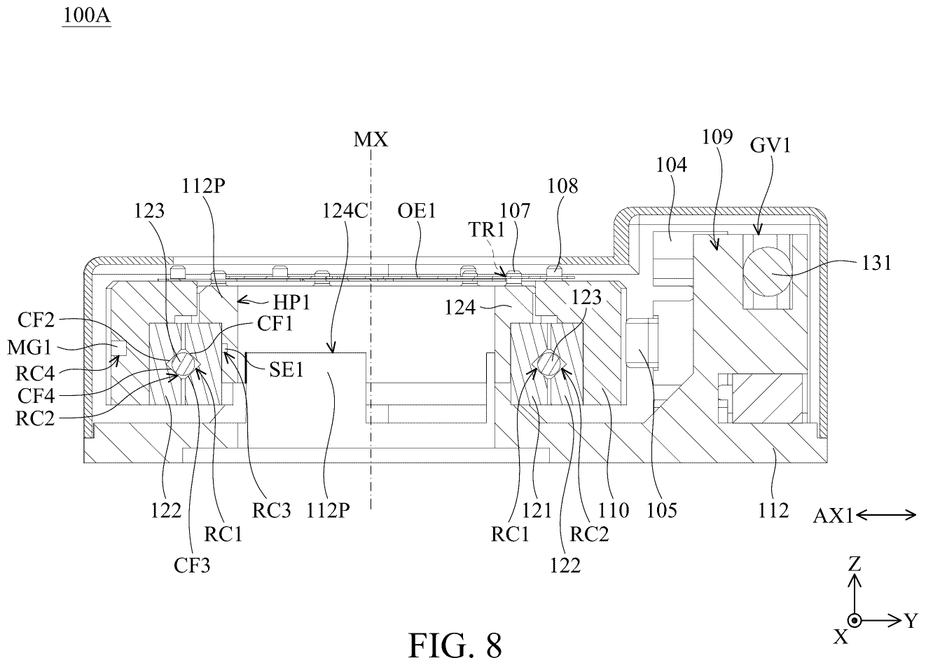

Please refer to FIG. 7 and FIG. 8. FIG. 7 is an exploded diagram of an optical element driving mechanism 100A according to another embodiment of the present disclosure, and FIG. 8 is a cross-sectional view of the optical element driving mechanism 100A according to another embodiment of the present disclosure. The optical element driving mechanism 100A is similar to the optical element driving mechanism 100. The optical element driving mechanism 100A also includes a first stator 121 and a first rotor 122.

In this embodiment, as shown in FIG. 7 and FIG. 8, the optical element driving mechanism 100A may further include a covering body 110 and a connecting member 124, the covering body 110 is fixedly connected to the first rotor 122, for example, by using glue (but it is not limited thereto), and the covering body 110 is not connected to the first stator 121. The connecting member 124 is fixedly connected to the first stator 121, for example, by using glue (but it is not limited thereto).

The connecting member 124 is configured to be affixed to the positioning protruding portion 112P. That is, the first stator 121 is affixed to the positioning protruding portion 112P by the connecting member 124. For example, the connecting member 124 may have at least one positioning slot 124C which is configured to engage with the corresponding positioning protruding portion 112P.

When viewed along the main axis MX, the connecting member 124 has a ring-shaped structure and forms a light-entering opening HP1, and the optical assembly OA includes a plurality of optical elements OE1 that selectively shield a portion of the light-entering opening HP1.

Similarly, the first stator 121 and the first rotor 122 respectively have a first accommodation groove RC1 and a second accommodation groove RC2, configured to accommodate the first rolling balls 123. In this embodiment, as shown in FIG. 8, the first accommodation groove RC1 has a first contact surface CF1 and a third contact surface CF3 which are configured to contact the first rolling balls 123, and the second accommodation groove RC2 has a second contact surface CF2 and a fourth contact surface CF4 which are configured to contact the first rolling balls 123.

The first contact surface CF1 is not parallel to the fourth contact surface CF4, the second contact surface CF2 is not parallel to the third contact surface CF3, and the first contact surface CF1 is not parallel to the second contact surface CF2.

Based on this configuration, the first rotor 122 can move more smoothly relative to the first stator 121. In addition, the configuration of the covering body 110 can further protect the first stator 121 and the first rotor 122 to prevent the first rotor 122 from being separated from the first stator 121 and the first rolling balls 123 when being impacted.

It should also be noted that in this embodiment, the optical element driving mechanism 100 also includes a plurality of fixed protruding portions 107 and a plurality of movable protruding portions 108, and each optical element OE1 also has a movable trench TR1 corresponding to the corresponding fixed protruding portion 107.

As shown in FIG. 8, each of the fixed protruding portion 107 is disposed on the connecting member 124 and passes through the corresponding movable trench TR1, and each of the movable protruding portion 108 is disposed on the covering body 110 and passes through the corresponding optical element OE1.

Therefore, when the first contact member 105 drives the covering body 110 and the first rotor 122 to rotate relative to the first stator 121, the covering body 110 drives each of the optical elements OE1 to rotate around the corresponding movable protruding portion 108, so that each of the fixed protruding portion 107 and the corresponding movable trench TR1 move relative to each other. The method of driving the plurality of optical elements OE1 to adjust the amount of incoming light is similar to the method of the aforementioned embodiment (FIG. 5 and FIG. 6), and therefore are not described in detail herein.

In this embodiments, the base 112, the connecting member 124 and the covering body 110 may be made of plastic material, and the first stator 121 and the first rotor 122 may be made of metal material, but they are not limited thereto. Based on this configuration, the fixed protruding portions 107 and the connecting member 124 can be integrally formed as one piece, and the movable protruding portions 108 and the covering body 110 can be integrally formed as one piece, for example, by using injection molding technology, thereby simplifying the manufacturing steps and reducing the manufacturing cost.

Similarly, as shown in FIG. 8, the first sensing element SE1 is disposed in the third accommodation groove RC3 of the positioning protruding portion 112P of the base 112, and the first sensing element SE1 is located between the base 112 and the covering body 110.

Specifically, the first sensing element SE1 is also located between the positioning protruding portion 112P and the first stator 121. Correspondingly, the first magnetic element MG1 is disposed in the fourth accommodation groove RC4 of the covering body 110, and the covering body 110 is located between the first magnetic element MG1 and the first rotor 122.

The first sensing element SE1 is configured to sense the magnetic field changes of the first magnetic element MG1. Based on the configuration of this embodiment, the sizes of the fourth accommodation groove RC4 and the first magnetic element MG1 can be increased, so that the sensing result of the first sensing element SE1 is more accurate.

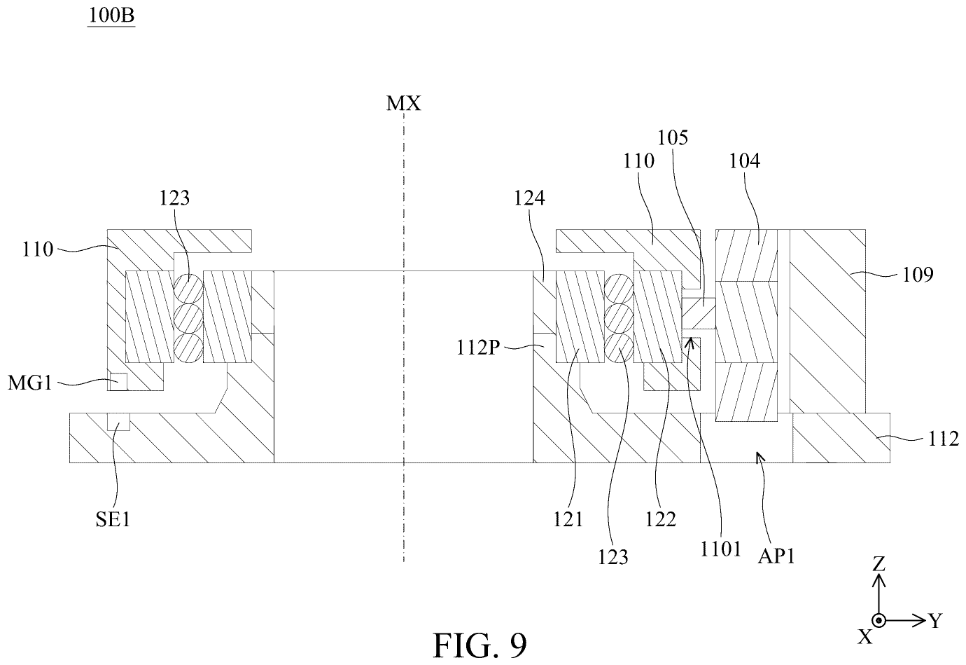

Please refer to FIG. 9 next. FIG. 9 is a cross-sectional view of an optical element driving mechanism 100B according to another embodiment of the present disclosure. The optical element driving mechanism 100B is similar to the optical element driving mechanism 100A and has the same components. For example, the covering body 110 also has a ring-shaped structure. However, in the embodiment of the optical element driving mechanism 100B, the covering body 110 has an opening slot 1101 extending circumferentially. The angular span of the opening slot 1101 is less than 180 degrees.

For example, the angular span of the opening slot 1101 is less than the maximum motion range (the rotatable angular range) of the first rotor 122. The first contact member 105 is configured to pass through the opening slot 1101 to contact the first rotor 122. Based on this configuration, the problem of particles generated by direct contact of the covering body 110 with the first contact member 105 can be avoided, thereby ensuring the imaging quality of the optical element driving mechanism 100B.

In addition, the first sensing element SE1 and the first magnetic element MG1 can be disposed at different positions. In this embodiment, the first sensing element SE1 is disposed on the base 112, and the first magnetic element MG1 is disposed on the covering body 110. There is no element disposed between the first sensing element SE1 and the first magnetic element MG1. Therefore, this configuration can further improve the accuracy of sensing.

In summary, the present disclosure provides an optical element driving mechanism 100, including a fixed assembly FA, a movable assembly MA, and a driving assembly DA. The movable assembly MA includes a first stator 121 and a first rotor 122. The first stator 121 is affixed to the base 112 of the fixed assembly FA, and the first rotor 122 is movably connected to the first stator 121. The driving assembly DA is configured to drive the first rotor 122 to move relative to the first stator 121 to drive the plurality of optical elements OE1 to move, so as to adjust the amount of light entering the optical element driving mechanism 100. The optical elements OE1 may be, for example, shielding blades forming an aperture structure, but they are not limited thereto.

In some embodiments, a plurality of fixed protruding portions 107 are disposed on the first stator 121 and pass through the movable trenches TR1 of the corresponding optical elements OE1, and a plurality of movable protruding portions 108 are disposed on the first rotor 122 and pass through the corresponding optical elements OE1. When the first rotor 122 rotates relative to the first stator 121, the first rotor 122 drives each optical element OE1 to rotate about the corresponding movable protruding portion 108, so that the fixed protruding portion 107 and the corresponding movable trench TR1 move relative to each other. The fixed protruding portions 107 may be integrally formed with the first stator 121, the movable protruding portions 108 may be integrally formed with the first rotor 122, and the fixed protruding portions 107 and the movable protruding portions 108 may be made of a metal material. Based on this configuration, the manufacturing steps can be simplified and the goal of miniaturization can be achieved.

In addition, the optical element driving mechanism 100 may further include a first positioning base 109 which is configured to position the driving assembly DA onto the installation part 112D of the base 112. The first positioning base 109 may have a first side protruding portion 1092 and a second side protruding portion 1093, and the installation part 112D may have a first guiding groove ST1 and a second guiding groove ST2 to guide the first side protruding portion 1092 and the second side protruding portion 1093, respectively. Based on this configuration, the convenience of assembly can be increased, and the problem that the first positioning base 109 rotates relative to the base 112 around the first central axis CX 1 when the driving assembly DA drives the first rotor 122 can be avoided.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly;
a movable assembly, configured to be connected to an optical assembly, wherein the movable assembly is movable relative to the fixed assembly; and
a driving assembly, configured to drive the movable assembly to move relative to the fixed assembly;
wherein when at least a portion of the movable assembly moves relative to the fixed assembly, the optical assembly moves relative to the movable assembly.

2. The optical element driving mechanism as claimed in claim 1, wherein
the fixed assembly includes a casing and a base;
the casing and the base are arranged along a main axis;
the movable assembly includes a first stator which is fixedly connected to the base;
the movable assembly further includes a first rotor which is movably connected to the first stator;
the movable assembly further includes a first rolling ball which is disposed between the first stator and the first rotor;
the first rotor rotates around a first rotating axis relative to the first stator by the first rolling ball;
the first rotating axis is parallel to the main axis; and
the first rotating axis overlaps the main axis.

3. The optical element driving mechanism as claimed in claim 2, wherein
the optical element driving mechanism further includes a first positioning base which is connected to the base;
the optical element driving mechanism further includes a first connecting element which extends along a first axis;
the first axis is perpendicular to the main axis; and
the first connecting element is configured to connect the driving assembly to the first positioning base.

4. The optical element driving mechanism as claimed in claim 3, wherein
the base has an installation part;
the first positioning base is configured to be inserted into the installation part along the first axis; and
the base has a first accommodation space which is configured to accommodate at least a portion of the driving assembly and the first positioning base.

5. The optical element driving mechanism as claimed in claim 4, wherein
the driving assembly has a first transfer assembly, a first contact member and a first power source;
the first power source is configured to generate a first driving force configured to push the first transfer assembly;
the first transfer assembly is configured to transmit the first driving force; and
the first contact member is disposed on the first transfer assembly and configured to transmit the first driving force.

6. The optical element driving mechanism as claimed in claim 5, wherein
the first accommodation space has a first avoiding space which corresponds to the first transfer assembly; and
the first contact member is configured to drive the first rotor to rotate relative to the first stator around the first rotating axis according to the first driving force.

7. The optical element driving mechanism as claimed in claim 6, wherein
when viewed along the main axis, the first positioning base has a plate-shaped structure;
the first positioning base has a main body, a first side protruding portion and a second side protruding portion;
the first side protruding portion and the second side protruding portion protrude from the main body along a second axis;
the installation part has a first guiding groove and a second guiding groove which are configured to accommodate the first side protruding portion and the second side protruding portion respectively; and
when viewed along the first axis, the first side protruding portion and the second side protruding portion each have a trapezoidal structure.

8. The optical element driving mechanism as claimed in claim 7, wherein
the main body has a first surface which is perpendicular to the second axis;
the second axis is perpendicular to the first axis and the main axis;
the first side protruding portion and the second side protruding portion respectively have a second surface and a third surface;
the second surface is not parallel to the third surface; and
the second surface is neither parallel nor perpendicular to the first surface.

9. The optical element driving mechanism as claimed in claim 8, wherein
the optical element driving mechanism further includes a first positioning element and a second positioning element which are configured to position the first positioning base at the installation part;
the first positioning base has a first positioning groove and a second positioning groove; and
the installation part further has a third positioning groove and a fourth positioning groove which respectively correspond to the first positioning groove and the second positioning groove.

10. The optical element driving mechanism as claimed in claim 9, wherein
the first positioning element is configured to be disposed in the first positioning groove and the third positioning groove;
the second positioning element is configured to be disposed in the second positioning groove and the fourth positioning groove; and
the first positioning element and the second positioning element are configured to push the first positioning base so that the first positioning base provides a pre-pressure to the first contact member.

11. The optical element driving mechanism as claimed in claim 10, wherein
when viewed along the main axis, the first positioning groove and the second positioning groove each have a polygonal structure;
when viewed along the main axis, the third positioning groove and the fourth positioning groove each have a polygonal structure;
the first positioning element and the second positioning element each have a spherical structure or a columnar structure; and
the first positioning element and the second positioning element are made of non-metallic material.

12. The optical element driving mechanism as claimed in claim 11, wherein
when viewed along the main axis, the first stator has a ring-shaped structure and forms a light-entering opening;
the optical assembly includes an optical element which is configured to selectively shield a portion of the light-entering opening; and
the optical element driving mechanism further includes a fixed protruding portion and a movable protruding portion which extend along the main axis.

13. The optical element driving mechanism as claimed in claim 12, wherein
the optical element has a movable trench which corresponds to the fixed protruding portion;
the fixed protruding portion is disposed on the first stator and passes through the movable trench;
the movable protruding portion is disposed on the first rotor and passes through the optical element; and
when the first rotor rotates relative to the first stator, the first rotor drives the optical element to rotate around the movable protruding portion as an axis, so that the fixed protruding portion and the movable trench move relative to each other.

14. The optical element driving mechanism as claimed in claim 13, wherein
the first stator and the first rotor are made of a metal material;
the first stator and the first rotor have a first accommodation groove and a second accommodation groove respectively;
the first rolling ball is disposed in the first accommodation groove and the second accommodation groove; and
the first rolling ball has a spherical structure.

15. The optical element driving mechanism as claimed in claim 14, wherein
when viewed along the main axis, the first stator and the first rotor each have a ring-shaped structure;
the first accommodation groove is circumferentially formed on the first stator;
the second accommodation groove is circumferentially formed on the first rotor;
the first accommodation groove has a first contact surface which is configured to contact the first rolling ball;
the second accommodation groove has a second contact surface which is configured to contact the first rolling ball;
the first accommodation groove or the second accommodation groove further has a third contact surface which is configured to contact the first rolling ball; and
the first contact surface, the second contact surface and the third contact surface are neither parallel to nor perpendicular to each other.

16. The optical element driving mechanism as claimed in claim 15, wherein
the base further has a positioning protruding portion, and the first stator is configured to be affixed to the positioning protruding portion;
the optical element driving mechanism further includes a first sensing element which is disposed at the positioning protruding portion;
the first sensing element is located between the positioning protruding portion and the first stator;
the optical element driving mechanism further includes a first magnetic element which is disposed on the first rotor;
the first sensing element is configured to sense magnetic field changes of the first magnetic element; and
the first rotor is located between the first magnetic element and the first stator.

17. The optical element driving mechanism as claimed in claim 11, wherein
the optical element driving mechanism further includes a covering body and a connecting member;
the covering body is fixedly connected to the first rotor;
the connecting member is fixedly connected to the first stator;
the base further has a positioning protruding portion, and the connecting member is configured to be affixed to the positioning protruding portion;
when viewed along the main axis, the connecting member has a ring-shaped structure and forms a light-entering opening; and
the optical assembly includes an optical element which is configured to selectively shield a portion of the light-entering opening.

18. The optical element driving mechanism as claimed in claim 17, wherein
the optical element driving mechanism further includes a fixed protruding portion and a movable protruding portion which extends along the main axis;
the optical element has a movable trench which corresponds to the fixed protruding portion;
the fixed protruding portion is disposed on the connecting member and passes through the movable trench;
the movable protruding portion is disposed on the covering body and passes through the optical element; and
when the first contact member drives the first rotor and the covering body to rotate relative to the first stator, the covering body drives the optical element to rotate around the movable protruding portion as an axis, so that the fixed protruding portion and the movable trench move relative to each other.

19. The optical element driving mechanism as claimed in claim 18, wherein
the base, the connecting member and the covering body are made of plastic material;
the first stator and the first rotor are made of metal material;
the covering body has a ring-shaped structure, and the covering body has an opening slot which extends circumferentially;
the angular span of the opening slot is less than 180 degrees; and
the first contact member is configured to pass through the opening slot to contact the first rotor.

20. The optical element driving mechanism as claimed in claim 19, wherein
the optical element driving mechanism further includes a first sensing element which is disposed at the base;
the first sensing element is located between the base and the covering body;
the optical element driving mechanism further includes a first magnetic element which is disposed on the covering body; and
the first sensing element is configured to sense magnetic field changes of the first magnetic element.
